(19) United States
(12) Patent Application Publication
(10) Pub. No.: US 2016/0033638 A1
(43) Pub. Date: Feb. 4, 2016

(54) HYBRID VIDEO CAMERA RADAR HOUSING

(71) Applicant: Alliance Wireless Technologies, Inc., Houston, TX (US)

(72) Inventor: Ron Silc, Cape Coral, FL (US)

(21) Appl. No.: 14/810,721

(22) Filed: Jul. 28, 2015

Related U.S. Application Data
(60) Provisional application No. 62/032,781, filed on Aug. 4, 2014.

(51) Int. Cl. G01S 13/86; G01S 13/93

(52) U.S. Cl. CPC G01S 13/867; G01S 13/931; G01S 2007/027

(57) ABSTRACT

An active vehicle safety system. The system comprises a housing configured to rigidly secure an imaging device and a radar device therein; a port configured to accept signals from the imaging device and the radar device and provide power to the imaging device and the radar device; and a display/alarm device for providing output related to the signals from the imaging device and the radar device. A connection from the port to the display/alarm device can be configured to provide images from the imaging device and alarms according to the signals from the radar device.

### CROSS REFERENCE TO RELATED PATENT APPLICATIONS

This patent application claims the priority and benefit of U.S. provisional patent application 62/032,781 entitled “Hybrid Video Camera Radar Housing”, filed on Aug. 4, 2014. This patent application therefore claims priority to U.S. Provisional Patent Application Ser. No. 62/032,781 which is incorporated herein by reference in its entirety.

### TECHNICAL FIELD

The present invention is related to methods and systems for housing hybrid detection systems. The invention is further related to methods and systems for integrating radar and imaging technology in a single housing.

### BACKGROUND

Large vehicles used to collect and transport solid waste burden the solid waste industry and the transportation infrastructure for everyone. The size of these vehicles creates a hazard because there are multiple positions surrounding the vehicle which are out of the operator's direct line of sight. As a result some vehicles, including front and rear loading trucks, are equipped with cameras to help the operator see portions of the surrounding environment blocked from their direct line of sight.

Because such vehicles create a public safety risk, comprehensive performance standards and reliability criteria have been established to insure that manufacturers are consistent in the performance, quality, and workmanship of the vehicles. In some cases this can include standardized camera locations on vehicles to provide rear views, street side views, curbside views, hopper views, and the like. It is common for the top national waste companies to mandate the use of video cameras and displays on their service trucks to prevent backing collisions, lane change accidents, and to improve driver efficiency.

However, all of these cameras (like rear view mirrors) are passive, meaning they require a driver's attention to be useful. Active safety systems are increasingly desired in order to help avoid driver distraction and mitigate the risks of collision. Therefore, a need exists for improved methods and systems for providing active safety systems to improve safety during the operation of a vehicle.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiment to provide safety devices.

It is another aspect of the disclosed embodiments to provide methods and systems for video cameras and radar devices associated with vehicles.

It is another aspect of the disclosed embodiments to provide a method and system for providing video cameras and radar devices in an integrated unit.

It is another aspect of the disclosed embodiments to provide a single safety device for attachment to a vehicle comprising a radar unit and a video unit.

Radar based alert systems can provide unique driver alert warnings to a driver when an obstacle is detected. This positive and active method of monitoring can be critical in preventing collisions. The present invention provides a means for combining passive video and active radar technologies to provide an enhanced fusion of technology to increase driver safety.

The invention includes a single housing configured to include both imaging detectors and radar detectors. The housing can be of any size, but is preferably configured to fit preformed grommets on service vehicles. The housing can be weather resistant and waterproof. The housing is formed with connections such that only a single cable is required to connect the housing and the instruments provided therein to the display inside the truck cab and power the internal sensors.

The aforementioned aspects and other objectives and advantages can now be achieved as described herein. An active vehicle safety system comprises a housing configured to rigidly secure an imaging device and a radar device therein; a port configured to accept signals from the imaging device and the radar device and provide power to the imaging device and the radar device; and a display/alarm device for providing output related to the signals from the imaging device and the radar device. A connection from the port to the display/alarm device can be configured to provide images from the imaging device and alarms according to the signals from the radar device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and together with the detailed description, serve to explain the embodiments disclosed herein.

FIG. 1A depicts a perspective view of an active safety system in accordance with the disclosed embodiments;

FIG. 1B depicts a side elevation view of an active safety system in accordance with the disclosed embodiments;

FIG. 2 depicts a block diagram of a wiring arrangement for an active safety system in accordance with the disclosed embodiments;

FIG. 3A depicts a 6 pin MiniDIN style PS/2 adaptor in accordance with an embodiment of the invention;

FIG. 3B is a photograph of a 6 pin MiniDIN style PS/2 adaptor in accordance with an embodiment of the invention;

FIG. 4A depicts a side elevation view of a housing associated with an active safety system in accordance with the disclosed embodiments;

FIG. 4B depicts a side elevation view of a housing associated with an active safety system in accordance with the disclosed embodiments;

FIG. 4C depicts a top view of a housing associated with an active safety system in accordance with the disclosed embodiments;

FIG. 4D depicts a perspective view of a housing associated with an active safety system in accordance with the disclosed embodiments;

FIG. 5A depicts a schematic view of an active safety system in accordance with an embodiment of the invention;

FIG. 5B depicts a schematic view of an active safety system in accordance with an embodiment of the invention;

FIG. 5C depicts a schematic view of an active safety system in accordance with an embodiment of the invention;

FIG. 6A depicts an image of an active safety system in accordance with an embodiment of the invention;

FIG. 6B depicts an image of an active safety system in accordance with an embodiment of the invention; and

FIG. 7 depicts a flow chart illustrating operational steps associated with a method for implementation of an active safety system in accordance with another embodiment of the invention.

### DETAILED DESCRIPTION

The particular values and configurations discussed in these non-limiting examples can be varied and are cited merely to illustrate at least one embodiment and are not intended to limit the scope thereof. The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

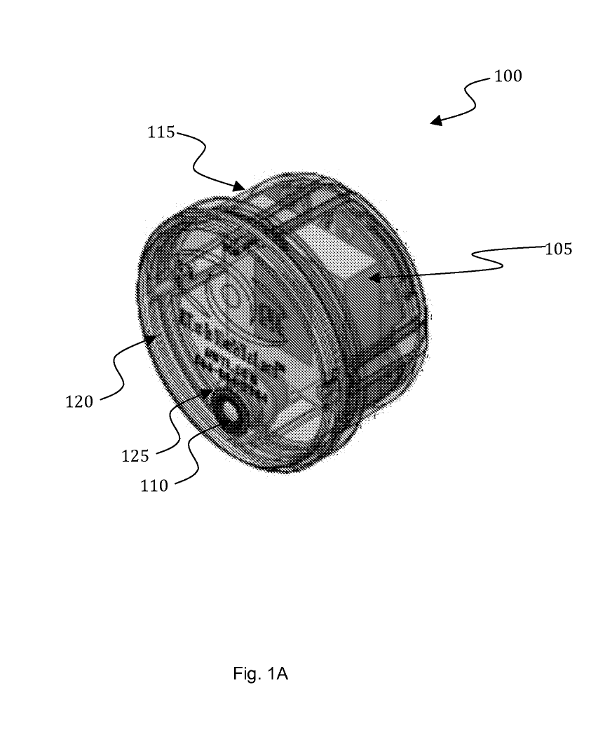

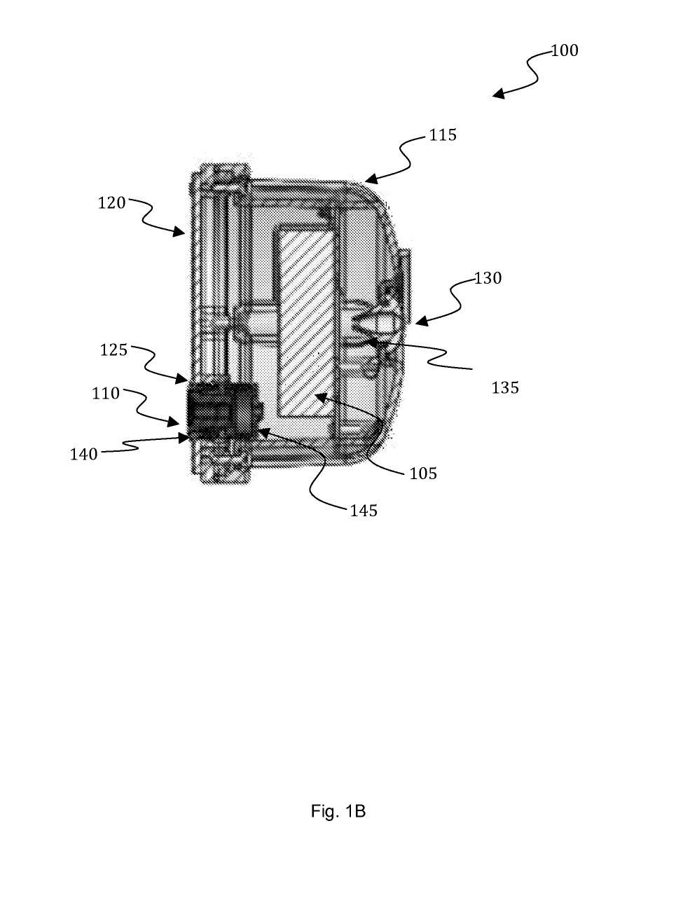

Disclosed are methods and systems for an integrated imaging and radar device. Various views of one embodiment of the device are shown in FIGS. 1A and 1B. The device 100 includes a housing 115 for integrating an imaging device 110 and a radar device 105. The housing 115 can include a faceplate 120 with an opening 125 form-fitted to an imaging device. A durable polymer or other such substance to keep the housing weather and water resistant may cover the form-fitted opening or sub-housing 125. The faceplate 120 may also be comprised of a material that allows the radar device 105 to operate properly and accurately while still ensuring the integrity of the housing against weather.

In one embodiment, the housing 115 can be formed to fit in a rubber grommet that is commonly integrated on service trucks. This way the housing 115 can be quickly and easily installed in many service vehicles without professional installation assistance.

The rear of the housing 115 includes a hybrid camera cable gland 130. The hybrid camera cable gland 130 is formed to allow a cable (or cables) to electrically connect with devices exterior to the cable housing while maintaining the housing 115 package seal against water and weather.

The housing 115 is preferably configured of metal, plastic, fiberglass, polymer, or any other durable material. This is important because the housing 115 is intended to be deployed on service trucks which experience a variety of weather, and are exposed to other hazardous external conditions which typical imaging and radar devices are not designed to handle.

The radar device 105 formed in the housing 115 may comprise any type of known radar device. Preferably, the radar device is a Doppler radar device. As shown in FIG. 1A and FIG. 1B, the radar device 105 can be fitted into the center of the housing 115 with electrical connections 135 provided at the rear of the device 105. The device 105 can be held in place via screws, bolts, snaps, or latches as desired. Alternatively, the housing 115 can be molded to form fit the radar device 105 so that when the housing 115 is sealed, the radar device 105 is rigidly held in place inside the housing 115.

Similarly, the imaging device 110 can comprise any known imaging device including a still camera, infra-red camera, video camera, or the like. Preferably, the imaging device 110 is a video camera. The video camera can be fitted on or near the lower rim of the housing 115 and can be held in place via screws, bolts, snaps, or latches. The faceplate 120 of the housing provides an opening or sub-housing 125 to allow the imaging device 110 to image the exterior environment. This opening 125 may be covered by a durable cover 140 made of plastic, glass, or other such material. In another embodiment, a specially selected and durable lens 140, configured to enhance the image collection of the imaging device may cover the opening depending on design considerations.

The electrical connections 145 for the imaging device 110 can be provided in the housing 110 and are preferably at the rear of the imaging device 110. It may be important to provide the imaging device 110 such that it does not obstruct the radar device also held in the housing 115.

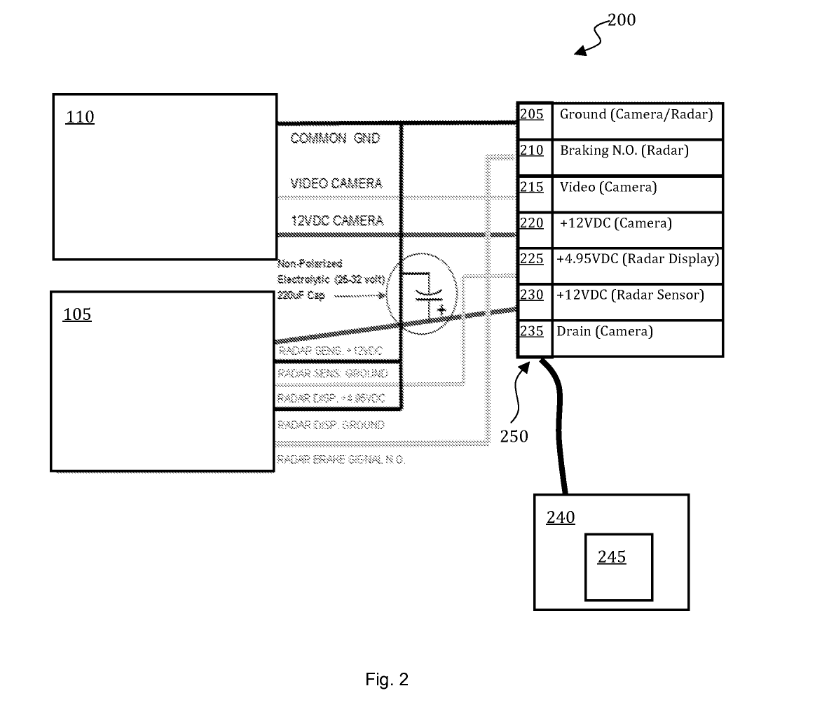

FIG. 2 illustrates a diagram 200 of the electrical integration of the imaging device 110 and radar sensor 105 within the housing 115 to a single fixture. The video camera 110 can preferably include a wired connection to a common ground port 205, a video out port 215, and a 12 volt DC camera power source 220. A drain 235 may also be provided.

The radar sensor 105 can provide wired attachment to a ground port 205 as well as the radar display 225. The radar can connect to a radar display port and to a 12 V DC power supply for the radar sensor 230. Additionally, the radar includes connection to a radar brake signal N.O 210.

The above connections can be integrated into a single interface 250 configured to connect to a cable that exits the housing 115 and connects to a display device and/or power supply 245 preferably provided in the cab of a vehicle 240. In a preferred embodiment, the display device and/or power device 245 may be embodied as a computing device, such as a computer, a cellular phone, tablet device, a standalone handheld device, or other such device. The device can be configured to accept signals from both the camera 110 and radar device 105. The combined data can be interpreted by the device 245. The device can provide constant imaging data of the surrounding environment. When the data from the radar device 105 indicates a collision is imminent, an active warning can be sounded via the device 245. The device 245 may further provide power via a battery pack or may be connected to the power supply of a vehicle 240 depending on design considerations.

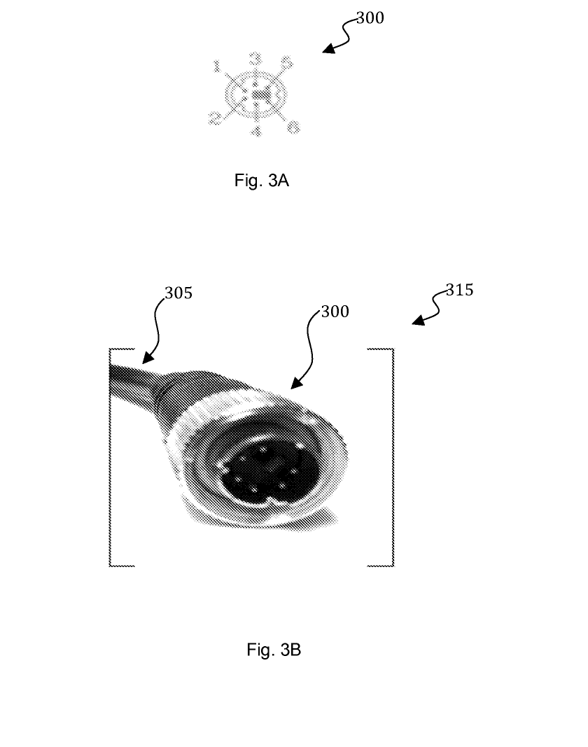

In a preferred embodiment, the port 250 is within the housing 115 and configured to interface with a threaded 6 pin MiniDIN style PS/2 adaptor 300 as shown in FIG. 3A. Pins 1-6, associated with the 6 pin MiniDIN style PS/2 adaptor are shown. It should be understood that other adaptors may alternatively be used. FIG. 3B shows an image 315 of a 6 pin MiniDIN style PS/2 adaptor 300 and cable 305 which may preferably be used in embodiments disclosed herein.

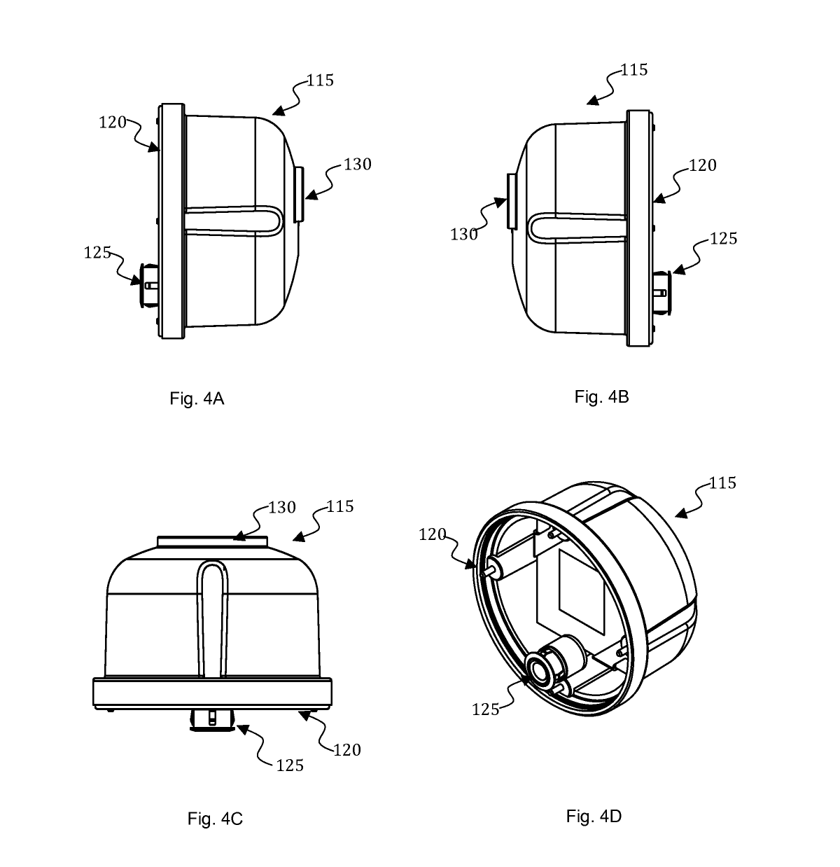

FIGS. 4A-4C illustrates further views of an integrated video and radar device in accordance with an embodiment of the invention. In particular, FIGS. 4A-C illustrates the exit wire location slot or gland 130 at the rear of the housing 115.

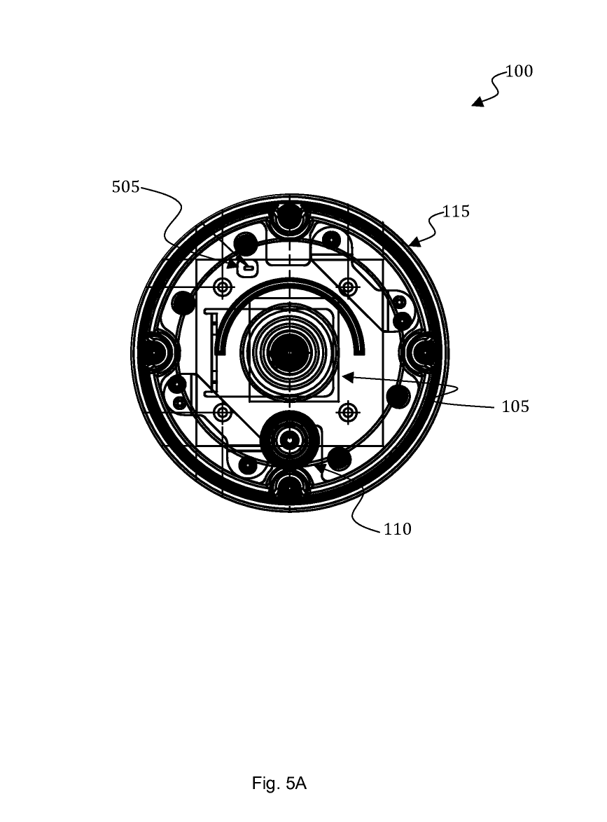

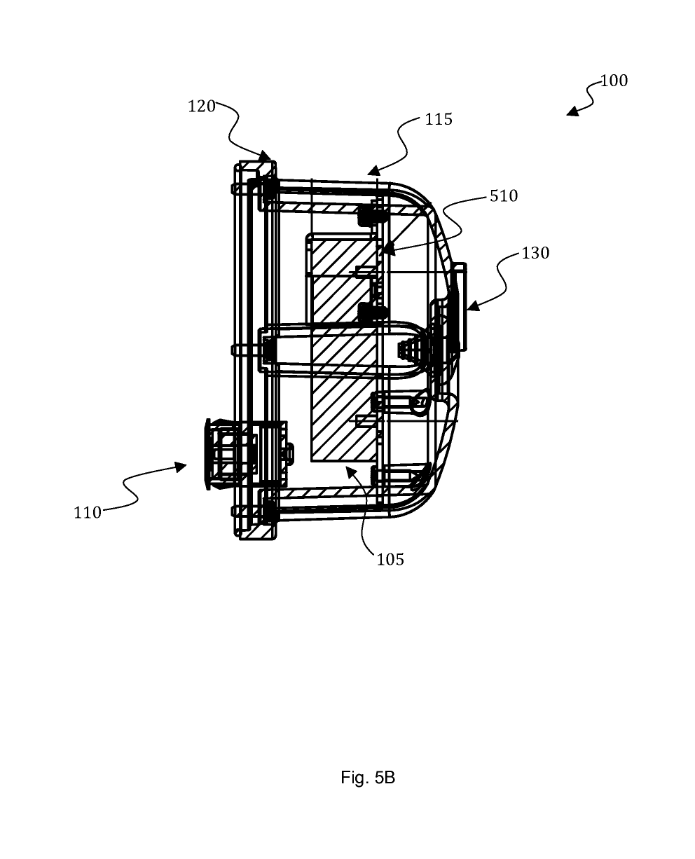

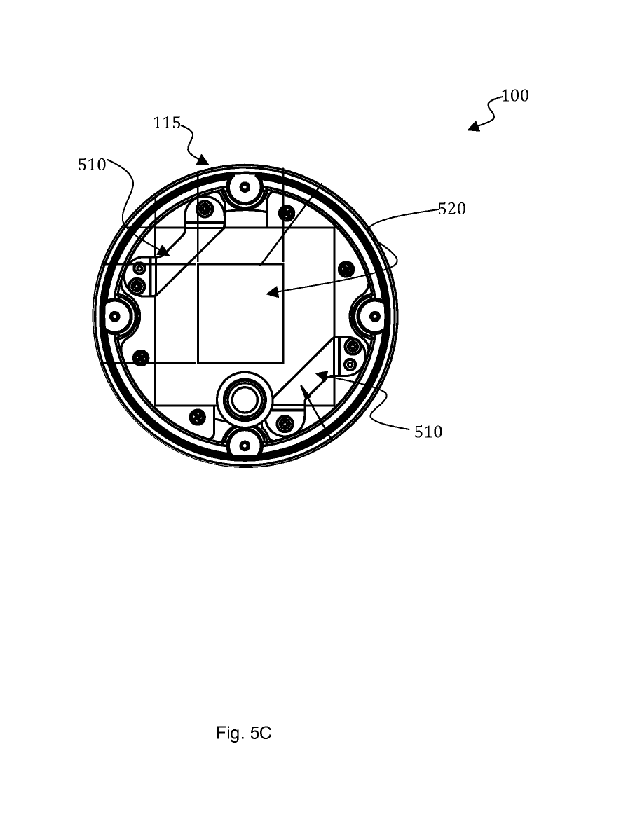

FIGS. 5A-C illustrate additional views of the system 100. In particular, in FIG. 5A an exit wire location 505 is shown. This exit wire location 505 may be embodied as the cable gland in certain embodiments. One major advantage of the present embodiments is the wired transmission of multiple signals transmitted via a single cable. This is advantageous because it is critically important that the housing 115 remain weather proof. Reducing the number of openings to the external environment decreases the chances the weatherproofing will be breached. Similarly, the single cable required also makes installation of the system simpler and less expensive, as only a single cable is required between the housing 115 and the monitoring device 245.

In FIG. 5B, a radar fixture plate 510 is illustrated inside housing 115. The radar fixture plate provides a means for holding the radar 105 securely in housing 115. FIG. 5C illustrates yet another view of housing 115. Here, an antenna patch area 520 is shown. The radar fixture plate 510 is also shown.

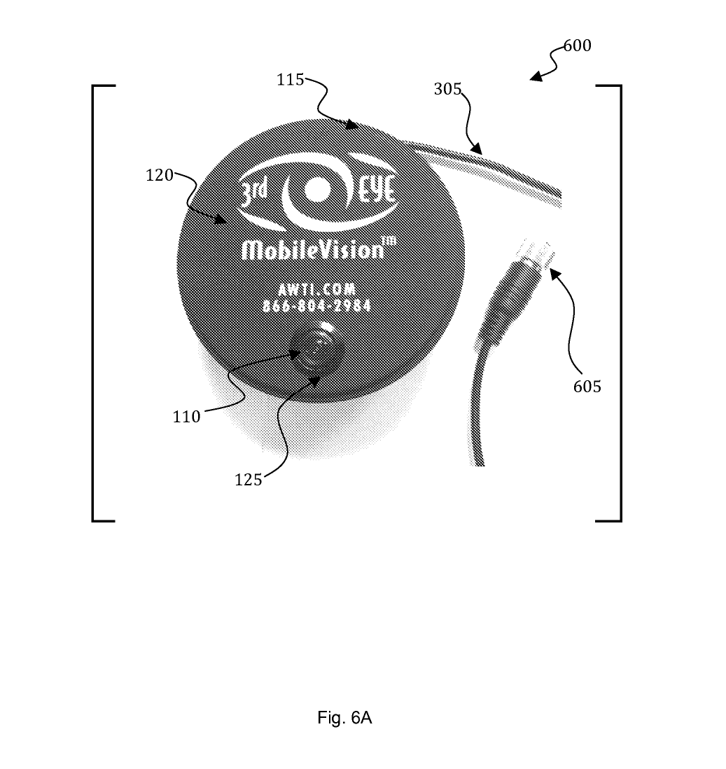

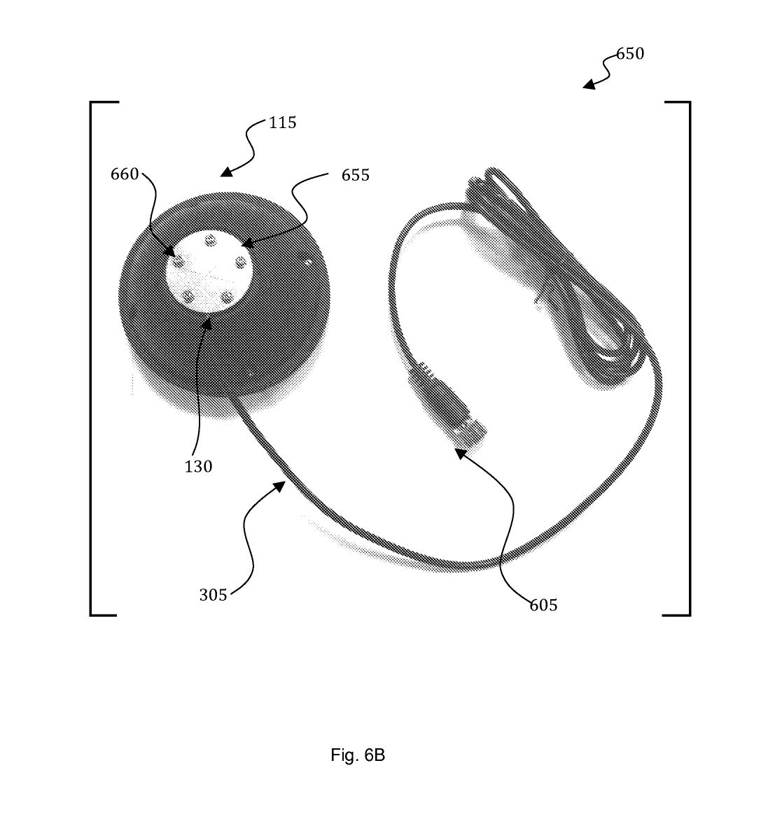

FIG. 6A and FIG. 6B include image 600 and image 650, respectively. FIG. 6A illustrates an embodiment of the invention including housing 115 covered with faceplate 120. A cable 305 is shown connected to an output port 605. Output port 605 can be connected to an output device, such as device 245 that may be used to provide data from the imaging device 110 and/or provide an alarm signal from the radar device 105. The faceplate 120 includes a covered opening or sub-housing 125 which provides the camera 110 a view of the external environment.

FIG. 6A also illustrates a cover over the opening in the faceplate that provides the imaging device a view of the external environment. In this case, the cover also serves as a lens for the imaging device. Note that the faceplate need not necessarily be see-through (for example, in the visible spectrum) in order for the Doppler radar to operate properly. In this embodiment, the faceplate appears black. It should be appreciated that the faceplate need only be configured to allow electromagnetic signals to pass though the faceplate so that the radar device can generate the signal and then after reflection receive the signal at the radar device within the housing.

FIG. 6B shows a removable metal cap 655 on the rear of the housing 115 that can be mounted via a plurality of screws 660, bolts, or the like. A plurality of screws, bolts, or other fasteners can also be used to secure the faceplate on the housing. FIG. 6B illustrates gland 130, which is weatherproof, and which may protrude from the bottom of metal cap 655.

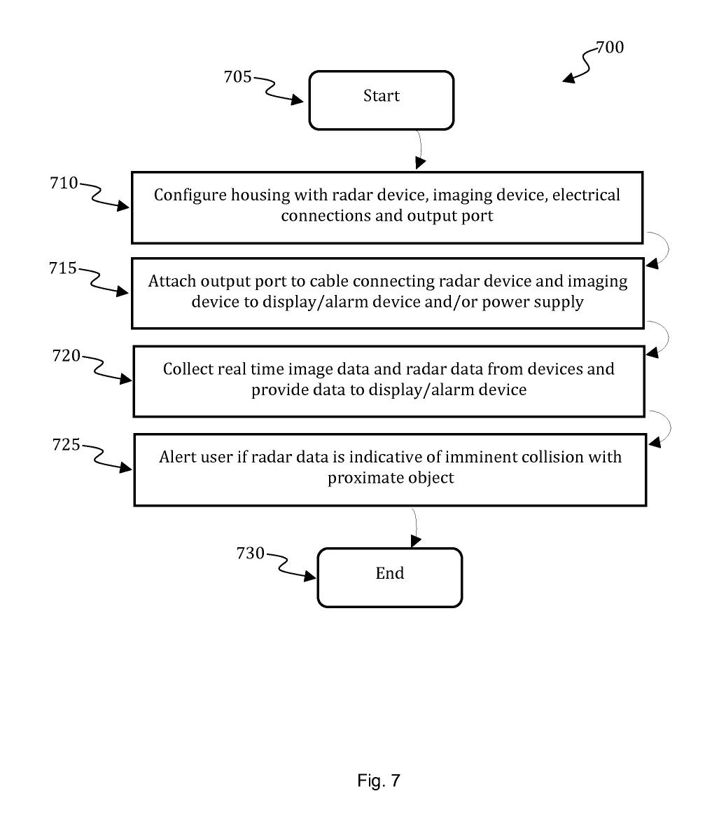

FIG. 7 is a flow chart 700 showing steps associated with the methods and systems disclosed herein. The method begins at step 705. The method 700 begins with the configuration of a system, such as system 100, which includes a housing with a radar device, an imaging device, and an electrical connection port for both devices.

Next, a cable can be connected from the port to a display/alarm device and/or power supply, such as device 245 which is preferably deployed in the cab of a vehicle at step 715. At step 720, the imaging device can collect images and provide them to the display device, at or near real time, and the radar device can be used to detect nearby objects at or near real time. It should be understood that step 720 can be performed continuously. As such, the system actively collects in real time, or nearly real time, data indicative of the environment surrounding the vehicle.

The display/alarm device uses signals from the radar device to determine if a collision with an object is imminent and can actively provide an alarm signal before such a collision occurs at step 725. In this way the system actively provides the driver of a vehicle data indicative of the external environment. The method then ends at step 730.

Based on the foregoing, it can be appreciated that a number of embodiments, preferred and alternative, are disclosed herein. For example, in one embodiment, an active vehicle safety system comprises a housing configured to rigidly secure an imaging device and a radar device therein; a port configured to accept signals from the imaging device and the radar device and provide power to the imaging device and the radar device; and a display/alarm device for providing output related to the signals from the imaging device and the radar device. A connection from the port to the display/alarm device can be configured to provide images from the imaging device and alarms according to the signals from the radar device.

It will be appreciated that variations of the above-disclosed and other features and functions, or alternatives thereof, may be desirably combined into many other different systems or applications. Also, it will be appreciated that various presently unforeseen or unanticipated alternatives, modifications, variations or improvements therein may be subsequently made by those skilled in the art which are also intended to be encompassed by the following claims.

What is claimed is:

1. A system comprising:
a housing configured to rigidly secure an imaging device and a radar device therein;
a port configured to accept signals from said imaging device and said radar device and provide power to said imaging device and said radar device; and
a display/alarm device for providing output related to said signals from said imaging device and said radar device.

2. The system of claim 1 further comprising:
a connection from said port to said display/alarm device configured to provide images from said imaging device and alarms according to said signals from said radar device.

3. The system of claim 1 further comprising:
a lens window formed in said housing configured to provide a lens associated with said imaging device a view of a surrounding environment.

4. The system of claim 1 further comprising a cable gland configured on said housing.

5. The system of claim 1 wherein said port comprises a 6 pin MiniDin.

6. The system of claim 1 further comprising a radar plate in said housing configured to mount said radar device.

7. The system of claim 1 further comprising a vehicle wherein said housing is fixedly attached to said vehicle.

8. The system of claim 7 wherein said housing is configured to fit in a pre-formed grommet associated with said vehicle.

9. A method for providing vehicle related safety information comprising:
rigidly securing an imaging device and a radar device within a housing wherein said imaging device and radar device collect data from a surrounding environment;
providing power to said imaging device and said radar device via a port;
providing signals from said imaging device and said radar device using said port;
providing data associated with said environment from said imaging device and radar device to a display/alarm device; and
providing output related to said signals from said imaging device and said radar device to a user in order to alert said user of said surrounding environment.

10. The method of claim 9 further comprising:
connecting said port to said display/alarm device configured to provide images from said imaging device and alarms according to said data from said radar device.

11. The method of claim 9 further comprising:
providing a lens associated with said imaging device a view of said surrounding environment via a lens window formed in said housing.

12. The method of claim 9 further comprising forming a cable gland on said housing.

13. The method of claim 9 wherein said port comprises a 6 pin MiniDin.

14. The method of claim 9 further comprising mounting said radar device on a radar plate in said housing.

15. The method of claim 9 further comprising attaching said housing to a vehicle.

16. The method of claim 15 further comprising mounting said housing in a pre-formed grommet associated with said vehicle.

17. An apparatus comprising:
a housing configured to rigidly secure an imaging device and a radar device therein;
a port configured to accept signals from said imaging device and said radar device and provide power to said imaging device and said radar device;
a display/alarm device for providing output related to said signals from said imaging device and said radar device;
a connection from said port to a display/alarm device configured to provide images from said imaging device and alarms according to said signals from said radar device;
a cable gland formed on said housing and configured to provide a weatherproof entry to said housing for said connection; and
a vehicle wherein said housing is fixedly attached to said vehicle.

18. The apparatus of claim 19 further comprising:
a lens window formed in said housing configured to provide a lens associated with said imaging device a view of a surrounding environment.

19. The apparatus of claim 17 wherein said port comprises a 6 pin MiniDin.

20. The apparatus of claim 17 wherein said housing is configured to fit in a pre-formed grommet associated with said vehicle.
